(19) United States
(12) Patent Application Publication
(10) Pub. No.: US 2007/0234914 A1
(43) Pub. Date: Oct. 11, 2007

(54) Tubular decorating arrangement

(75) Inventor: Damian Pawel Mozdzen, Piotrkow Trybunalski (PL)

Correspondence Address: NIXON & VANDERHYE, PC, 901 NORTH GLEBE ROAD, 11TH FLOOR, ARLINGTON, VA, 22203, US

(73) Assignee: Euram H.R. Ltd., Houston, TX (US)

(21) Appl. No.: 11/377,645

(22) Filed: Mar. 17, 2006

(51) Int. Cl. B41K 1/38

(52) U.S. Cl. 101/327

(57) ABSTRACT

Tubular decorating arrangement comprises a transferring device arranged for transferring a decorative pattern to objects and provided with an operating surface suitable for interacting with said objects, said tubular decorating arrangement comprising at least one tubular portion on which said operating surface is obtained, said at least one tubular portion being peelably connected to a further operating surface (of said transferring device suitable for interacting with said objects after said at least one tubular portion has been removed from said transferring device.

The invention relates to a tubular decorating arrangement. The tubular decorating arrangement may be used for decorating ceramic products.

Decorating rollers are known comprising a supporting element with which a printing sleeve is associated.

An operating surface of the printing sleeve is arranged for interacting with objects to be decorated for transferring onto the objects a decorating material, for example a ceramic glaze in the case of ceramic products.

On the aforementioned surface there is obtained a plurality of cavities—of small dimensions—that define a decorative pattern that has to be reproduced on the objects.

The cavities receive the decorating material and transfer the decorating material to the objects when the decorating rollers are placed in contact with the objects.

The printing sleeve can be made of deformable polymeric material, for example of silicone rubber.

The supporting element can be made of fabric and be fixed firmly to the printing sleeve, for example through gluing.

Alternatively, the supporting element can comprise a stiffening sheet made of plastics that is substantially unextendable and that is fixed to, or embedded in, the printing sleeve.

The supporting element and the printing sleeve are fixed to flanges that enable the decorating rollers to be mounted on decorating machines.

Decorating belts are furthermore known that are made in a substantially similar manner to the decorating rollers disclosed above.

During operation, a decorating roller (or a decorating belt) is rotated so that the operating surface of the printing sleeve interacts with a face of an object to be decorated that is moved with respect to the decorating roller by means of a conveying device comprising, for example, a conveyor belt that supports the object.

A drawback of the decorating rollers disclosed above is that the operating surface is subject to great wear.

Decorating rollers in fact interact with a great number of objects per unit of time, these objects being provided with a face to be decorated made of a material that is abrasive to a certain extent.

When the decorative surface has deteriorated, the dimensions of the cavities obtained therein are different from preset dimensions that the cavities had initially, i.e. before the start of the operating life of the decorating rollers. The decorative pattern may be consequently unacceptably altered. Known decorating rollers have to be replaced once the operating surface thereof is spoilt.

The worn-out rollers are eliminated.

This involves a significant waste of material inasmuch as the silicone rubber that forms the printing sleeve, the fabric, or, respectively, the stiffening sheet cannot be recycled, with significant increase of costs.

Decorating belts have similar drawbacks to those of decorating rollers.

An object of the invention is to improve known decorating rollers and decorating belts.

A further object of the invention is to obtain a tubular decorating arrangement provided with an extended working life.

According to the invention, a tubular decorating arrangement is provided, comprising a transferring device arranged for transferring a decorative pattern to objects and provided with an operating surface suitable for interacting with said objects, wherein said tubular decorating arrangement comprises at least one tubular portion on which said operating surface is obtained, said at least one tubular portion being peelably connected to a further operating surface of said transferring device suitable for interacting with said objects after said at least one tubular portion has been removed from said transferring device.

Owing to the invention, it is possible to obtain a tubular decorating arrangement in which, when the operating surface is worn, the at least one tubular portion is removed, making the further operating surface available.

In this way, when the further operating surface is damaged, it is not necessary to replace the transferring device with further transferring device provided with an undamaged operating surface, but it is sufficient to remove the at least one tubular portion.

The invention can be better understood and carried out with reference to the attached drawings, that illustrate some embodiments thereof by way of non-limitative example, in which:

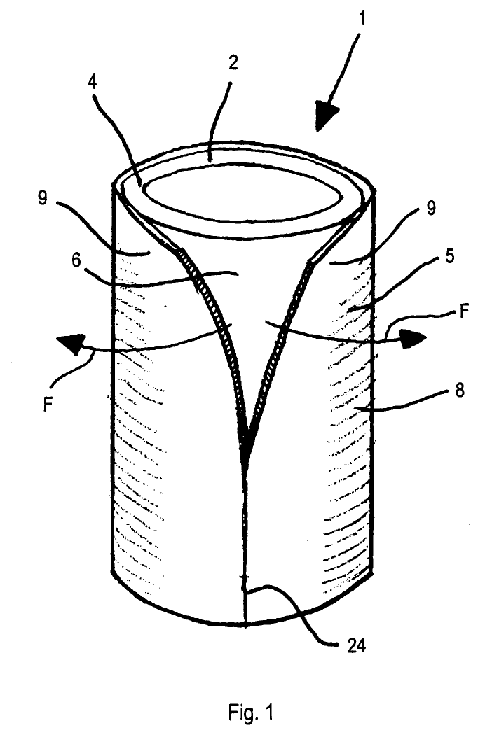

FIG. 1 is a perspective view of the tubular decorating arrangement;

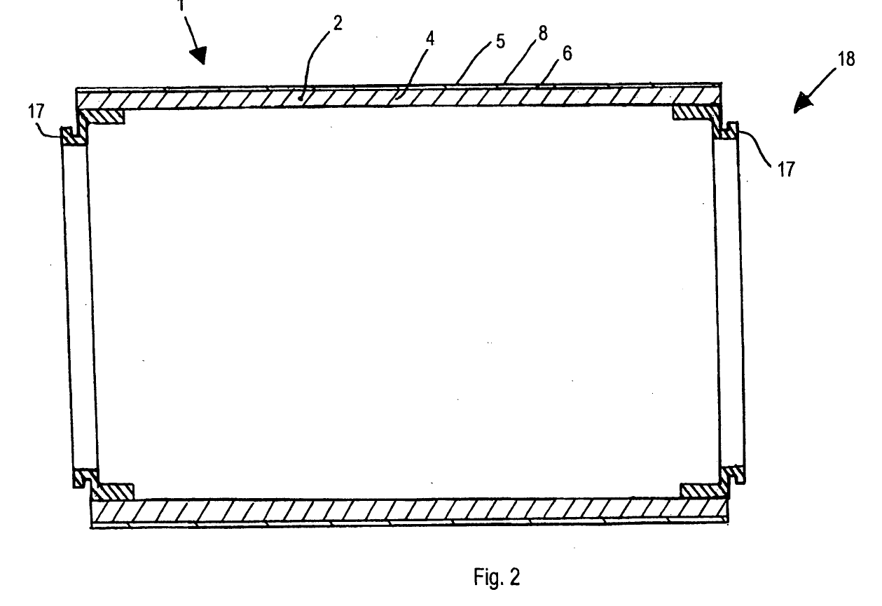

FIG. 2 is a longitudinal section of tubular decorating arrangement associated with flange members for defining a decorating roller device;

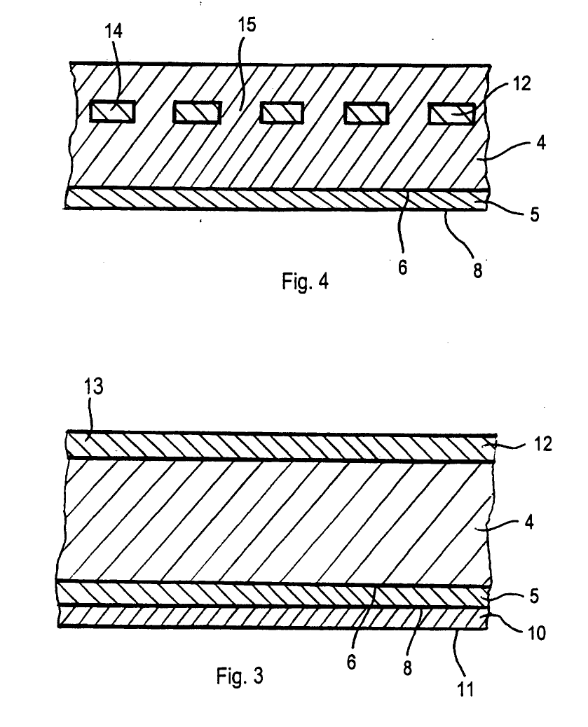

FIG. 3 is a fragmentary cross section of an embodiment of the tubular decorating arrangement;

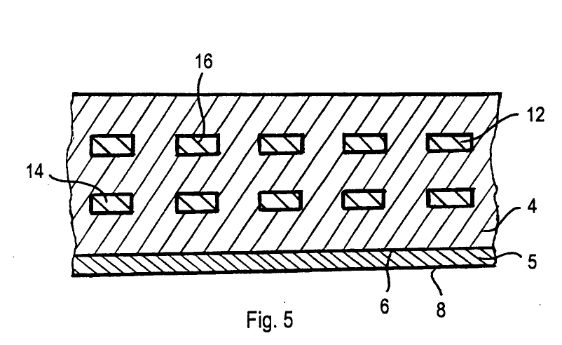

FIG. 4 is a section like the one in FIG. 3 that shows a further embodiment of the tubular decorating arrangement;

FIG. 5 is a section like the one in FIG. 3 that shows a still further embodiment of the tubular decorating arrangement;

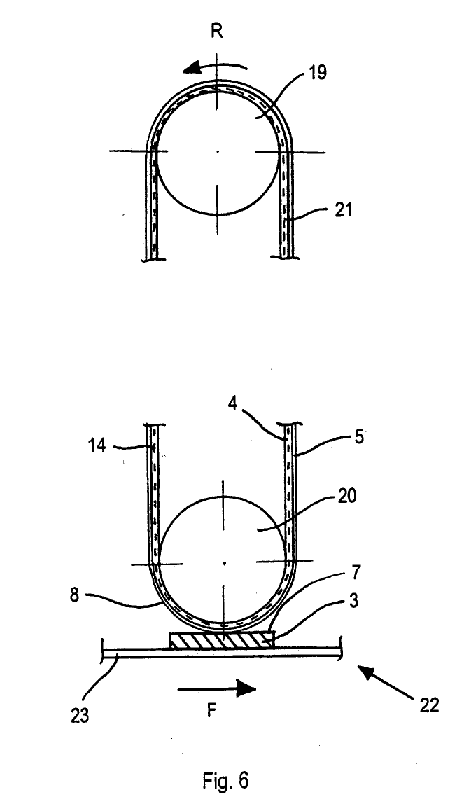

FIG. 6 is a section taken along a vertical plane of a decorating apparatus comprising a tubular decorating arrangement defining a decorating belt device.

With reference to FIGS. 1 and 2, tubular decorating arrangement 1 is shown comprising a transferring device 2 arranged for transferring a decorating material to an object to be decorated.

In particular, the transferring device 2 can transfer a ceramic glaze to a face of ceramic products 3 (FIG. 6).

The transferring device 2 comprises a printing sleeve 4 comprising a first operating surface 6 to which a tubular portion 5 is peelably associated.

The tubular portion 5 is fixed to the printing sleeve 4 in a sufficiently firm manner to prevent mutual sliding during operation.

The tubular portion 5, nevertheless, is associated with the printing sleeve 4 so as to be detachable from the tubular portion 5 during the peeling operation.

The printing sleeve 4 and the tubular portion 5 can be made of elastomeric material, for example silicone rubber.

The tubular portion 5 comprises a second operating surface 8 arranged for interacting with a face 7 (FIG. 6) of the ceramic products 3 for depositing the ceramic glaze thereupon.

The second operating surface 8 may comprise a plurality of cavities arranged so as to define an ornamental pattern that has to be reproduced on the ceramic products 3.

The cavities can be obtained by engraving the second operating surface 8, for example by means of a laser ray.

The cavities are arranged for receiving the ceramic glaze and depositing the ceramic glaze on the ceramic products 3, when the ceramic products 3, moved by a conveying device, interact with the tubular decorating arrangement 1.

Also the first operating surface 6 is arranged for being engraved in such a way as to obtain an ornamental pattern that has to be impressed on the ceramic products 3.

If the second operating surface 8 is worn because of the contact with the ceramic products 3—and therefore the degree of definition of the ornamental pattern that the second operating surface 8 transfers has become qualitatively unacceptable—it is possible to engrave the transferring device 2, for example by means of a blade, and remove the tubular portion 5 from the printing sleeve 4.

In the transferring device 2 an engraving 24 is made that partially or entirely cuts the thickness of the tubular portion 5, but does not reach the printing sleeve 4, so as not to damage the first operating surface 6.

As shown in FIG. 1, the tubular portion 5 can be removed from the printing sleeve 4 by removing from one another—as indicated by the arrows F—strips 9 generated by the engraving 24.

In this way, the first operating surface 6 is made available that can interact with the ceramic supports 3 for decorating them once a desired ornamental pattern has been obtained on the operating surface 6, for example by means of engraving.

As shown in FIG. 3, the transferring device 2 may comprise a plurality of tubular portions, instead of a sole tubular portion.

In particular, the transferring device 2 comprises a further tubular portion 10 peelably associated to the tubular portion 5.

In particular, the further tubular portion 10 is fixed to the tubular portion 5 at the second operating surface 8 and is provided with a third operating surface 11.

Also the third operating surface 11 is arranged for being engraved so as to obtain an ornamental pattern that has to be impressed on the ceramic products 3.

In this case, when the third operating surface 11 is worn, it is possible to make an engraving in the transferring device 2 that—partially or completely—cuts the further tubular portion 10, but not the tubular portion 5, so as not to damage the second operating surface 8.

Subsequently, the further tubular portion 10 is removed from the transferring device 2, making the second operating surface 8 available.

Still subsequently, when also the second operating surface 8 is worn, it is possible to remove the tubular portion 5 from the transferring device 2 in the manner disclosed with reference to FIG. 1.

In an embodiment that is not shown, it is possible to provide a still greater number of tubular portions that are peelably connected to, and removable in succession from, the transferring device.

Still with reference to FIG. 3, the transferring device 2 comprises a supporting arrangement 12 provided with a liner 13, for example made of fabric, fixed to an opposite side of the printing sleeve 4 with respect to the tubular portion 5 and to the further tubular portion 10.

With reference to FIG. 4, the supporting arrangement 12 comprises a laminar element 14 embedded into the printing sleeve 4.

The laminar element 14 can be made of substantially unextendable plastics, so that the transferring device 2 has a certain stiffness.

The laminar element 14 is provided with a plurality of through holes 15, arranged for enabling the elastomeric material that forms the printing sleeve 4 to position itself at opposite faces of the laminar element 14, during manufacture of the transferring device 2.

The holes 15 also act as fixing promoting elements that ensure better adhesion of the printing sleeve 4 to the laminar element 14.

With reference to FIG. 5, the supporting arrangement 12 comprises, in addition to the laminar element 14, a further laminar element 16, which is also embedded into the printing sleeve 4, so as to be further from the tubular portion 5 with respect to the laminar element 14.

The further laminar element 16 is shaped in a similar way to the laminar element 14.

In an embodiment that is not shown, the transferring device 2 may comprise a stiff frame, for example made of metal, that supports the printing sleeve 4 and the tubular portion 5.

Between the printing sleeve 4 and the stiff frame a soft layer may be interposed, for example in spongy plastics.

Owing to the invention, when the operating surface arranged in a more outer position of the tubular decorating arrangement 1 is worn, it is possible to make available at least one further operating surface, arranged in an inner part of the tubular decorating arrangement, removing at least one corresponding tubular portion peelably connected to the transferring device.

The tubular decorating arrangement therefore has a working life that is much longer than the working life of prior-art decorating rollers and decorating belts.

Furthermore, as the tubular decorating arrangement has to be replaced less frequently with respect to the prior-art decorating rollers and decorating belts, the cost of the supporting arrangement, i.e. of the liner 13, of the laminar element 14 and of the further laminar element 16—that constitute a significant fraction of the entire cost of the tubular decorating arrangement—can be amortized over a longer working life.

As shown in FIG. 2, the tubular decorating arrangement 1 can be associated with a pair of circular end flanges 17 so as to define decorating roller device 18.

The circular end flanges 17 enable the tubular decorating arrangement 1 to be mounted onto usual decorating machines.

With reference to FIG. 6, a tubular decorating arrangement 1 is shown that defines a decorating belt device 21 extending between a first roller 19 and a second roller 20.

The first roller 19 and the second roller 20 are positioned at different vertical heights.

The decorating belt device 21 is rotatable, as indicated by the arrow R.

A conveying arrangement 22 is associated with the decorating belt device 21, the conveying arrangement 22 comprising a conveyor belt 23 that advances the ceramic products 3—as shown by the arrow F—to make the ceramic products 3 interact with the tubular decorating arrangement 1.

The tubular decorating arrangement 1 can be obtained by a centrifugal casting of polymer material, for example silicone rubber, in a forming mould.

The forming mould comprises a casing, for example cylindrical, that is rotatable around a respective longitudinal axis.

A preset quantity of silicone rubber precursor is introduced into the forming mould. Subsequently, the casing is rotated so that the silicone rubber covers a side wall of the casing for defining the tubular portion, after which the casing is arrested.

After a certain time, a further preset quantity of silicone rubber precursor is introduced inside the forming mould.

The casing is again rotated so that the silicone rubber adheres firmly, but removably, to an internal zone of the tubular portion for defining the printing sleeve.

In an embodiment, the laminar element 14 (and the further laminar element 16, if any) can be positioned inside the casing before the further preset quantity of silicone rubber precursor is poured inside the casing.

When the casing is rotated, the silicone rubber precursor, by passing through the holes 15, can be arranged at both the faces of the laminar element 14.

In this way, at the end of forming, the laminar element 14 is embedded into the printing sleeve 4.

It is possible to obtain a tubular decorating arrangement comprising a plurality of peelable tubular portions, making with the methods illustrated above a plurality of overlying layers of silicone rubber, before obtaining the printing sleeve.

1. A tubular decorating arrangement, comprising a transferring device arranged for transferring a decorative pattern to objects and provided with an operating surface suitable for interacting with said objects, wherein said tubular decorating arrangement comprises at least one tubular portion on which said operating surface is obtained, said at least one tubular portion being peelably connected to a further operating surface of said transferring device suitable for interacting with said objects after said at least one tubular portion has been removed by said transferring device.

2. Tubular decorating arrangement according to claim 1, wherein said at least one tubular portion comprises a plurality of tubular portions arranged to form successive layers of said transferring device.

3. Tubular decorating arrangement according to claim 1, wherein said transferring device comprises a printing sleeve arrangement with which said at least one tubular portion is associated, and a supporting arrangement.

4. Tubular decorating arrangement according to claim 2, wherein said transferring device comprises a printing sleeve arrangement with which said at least one tubular portion is associated, and a supporting arrangement.

5. Tubular decorating arrangement according to claim 3, wherein said supporting arrangement comprises a supporting element fixed to a zone of said printing sleeve arrangement opposite a further zone of said printing sleeve arrangement with which said at least one tubular portion is associated.

6. Tubular decorating arrangement according to claim 4, wherein said supporting arrangement comprises a supporting element fixed to a zone of said printing sleeve arrangement opposite a further zone of said printing sleeve arrangement with which said at least one tubular portion is associated.

7. Tubular decorating arrangement according to claim 5, wherein said supporting element is made of fabric.

8. Tubular decorating arrangement according to claim 6, wherein said supporting element is made of fabric.

9. Tubular decorating arrangement according to claim 3, wherein said supporting arrangement comprises a laminar arrangement embedded in said printing sleeve arrangement.

10. Tubular decorating arrangement according to claim 4, wherein said supporting arrangement comprises a laminar arrangement embedded in said printing sleeve arrangement.

11. Tubular decorating arrangement according to claim 9, wherein said laminar arrangement comprises a plurality of laminar elements that are spaced apart from one another.

12. Tubular decorating arrangement according to claim 10, wherein said laminar arrangement comprises a plurality of laminar elements that are spaced apart from one another.

13. Tubular decorating arrangement according to claim 9, wherein said laminar arrangement is provided with a plurality of through holes.

14. Tubular decorating arrangement according to claim 10, wherein said laminar arrangement is provided with a plurality of through holes.

15. Tubular decorating arrangement according to claim 11, wherein said laminar arrangement is provided with a plurality of through holes.

16. Tubular decorating arrangement according to claim 12, wherein said laminar arrangement is provided with a plurality of through holes.

17. Tubular decorating arrangement according to claim 1, wherein said at least one tubular portion is made of deformable material.

18. Tubular decorating arrangement according to claim 2, wherein said at least one tubular portion is made of deformable material.

19. Tubular decorating arrangement according to claim 1, wherein said transferring device defines a decorating roller device.

20. Tubular decorating arrangement according to claim 1, wherein said transferring device defines a decorating belt device.
